(19) United States
(12) Patent Application Publication
(10) Pub. No.: US 2013/0273276 A1
(43) Pub. Date: Oct. 17, 2013

(54) AIRBAG AND METHOD FOR MANUFACTURING THE SAME

(71) Applicants: In Sik Han, Daegu (KR); Chang Bae Lee, Uiwang-si (KR); Oh-Hwan Kim, Chilgok-gun (KR); Jung-Hoon Youn, Gumi-si (KR); Jung Ha Kim, Gumi-si (KR)

(72) Inventors: In Sik Han, Daegu (KR); Chang Bae Lee, Uiwang-si (KR); Oh-Hwan Kim, Chilgok-gun (KR); Jung-Hoon Youn, Gumi-si (KR); Jung Ha Kim, Gumi-si (KR)

(73) Assignee: KOLON INDUSTRIES, INC., Gwacheon-si, Gyeonggi-do (KR)

(21) Appl. No.: 13/824,252

(22) PCT Filed: Oct. 21, 2011
(86) PCT No.: PCT/KR2011/007901

§ 371 Date: May 24, 2013

(30) Foreign Application Priority Data
Oct. 21, 2010 (KR) 10-2010-0102798

(51) Int. Cl. B60R 21/235; B60R 21/231; D06C 19/00; D05B 13/00; D06B 1/00

(52) U.S. Cl. CPC B60R 21/235; D05B 13/00; D06B 1/00; D06C 19/00; B60R 21/231
USPC 428/35.2; 28/143; 28/165; 28/169; 28/170

(57) ABSTRACT

Disclosed are an airbag which can endure great external impact as well as high temperature and high pressure and is thus useful as an external airbag and a method for manufacturing the same. The airbag includes: a fabric containing an aramid fiber having an young's modulus of 600 to 1000 g/d and a tenacity of 20 to 30 g/d, and having a cover factor of 1500 to 2100, and a coating layer formed on the surface of the fabric, wherein a seam strength of an adhered member measured in accordance with ASTM D 1683 is 200 to 600 kgf/20 mm.

### TECHNICAL FIELD

The present invention relates to an airbag and a method for manufacturing the same. More specifically, the present invention relates to an airbag for automobiles and a method for manufacturing the same.

### BACKGROUND ART

Airbags protect passengers when front or side collision of driving automobiles occurs. Airbags manufactured in a predetermined shape are mounted on automobiles in a bent state. When impact applied to automobiles is sensed by an impact sensor, gunpowder explodes, gas is rapidly fed into an airbag cushion and a folded airbag expands and spreads out. The expanded and spread airbag contacts the entire upper body of a driver and absorbs a part of impact load caused by collision. In addition, when the expanded airbag collides with the driver who springs forward by the law of inertia, a gas present in the airbag is discharged through an outlet formed in the airbag, thus offsetting the collision.

Research associated with automobile airbags which has been conducted to date has focused on internal airbags to prevent damage to passengers by automobile collision. Examples of internal airbags include driver's seat airbag, passenger's seat airbags, curtain airbags and seat-side airbags.

A principal function of internal airbags is to prevent impact caused by automobile collision from being directly applied to passengers. For this reason, internal airbags cannot completely secure passenger safety.

Accordingly, at present, research associated with external airbags to reduce impact applied to automobiles when the automobiles collide with obstacles is being conducted.

External airbags directly collide with external objects, unlike internal airbags. Such direct collision causes great impact to external airbags and high friction to the surface of external airbags. Furthermore, a great amount of gunpowder is used in order to expand a wide area of airbags. For this reason, high pressure and heat are applied to external airbags.

Conventional airbags have commonly been manufactured using a fabric containing nylon 66 fibers. However, airbags made of nylon 66 fibers disadvantageously cannot endure strong impact, friction, high temperature and high pressure and are thus readily damaged, since the nylon 66 fabric has relatively low heat resistance and tenacity.

In addition, conventional airbags have been manufactured by joining fabrics using nylon sewing yarns. However, conventional airbags used as external airbags made of nylon sewing yarns are disadvantageously broken due to strong impact, friction, high temperature, and high pressure, since nylon sewing yarns do not have sufficient strength.

### DISCLOSURE

### Technical Problem

Therefore, the present invention is directed to an airbag and a method for manufacturing the same which can prevent problems related to restrictions and disadvantages of the related art.

It is one aspect of the present invention to provide an airbag which can endure great external impact as well as high temperature and high pressure and is thus useful as an external airbag.

It is another aspect of the present invention to provide a method for manufacturing an airbag which can efficiently endure large external impact as well as high temperature and high pressure and is thus useful as an external airbag.

The aspects, features and advantages of the present invention will be described below or clearly understood to those having an ordinary knowledge in the art.

### Technical Solution

Accordingly, in accordance with one aspect of the present invention, provided is an airbag comprising: a fabric comprising an aramid fiber having an young's modulus of 600 to 1000 g/d and a tenacity of 20 to 30 g/d, and having a cover factor of 1500 to 2100; and a coating layer formed on the surface of the fabric, wherein a seam strength of a joined portion measured in accordance with ASTM D 1683 is 200 to 600 kgf/20 mm.

In accordance with another aspect of the present invention, provided is a method for manufacturing an airbag, including: preparing a fabric comprising an aramid fiber having an young's modulus of 600 to 1000 g/d and a tenacity of 20 to 30 g/d, and having a cover factor of 1500 to 2100; scouring the fabric; coating a resin on the surface of the scoured fabric; cutting the coated fabric to a predetermined shape; and joining the cut fabric using a sewing yarn comprising an aramid fiber such that a seam strength of 200 to 600 kgf/20 mm is obtained.

The fore-mentioned general description and the following detailed description are provided only for illustration or explanation of the present invention and should be construed as being given for better understating of the claimed invention.

### Advantageous Effects

The airbag according to the present invention can efficiently endure great external impact since it comprises a fabric containing aramid fibers with superior physical properties.

The airbag according to the present invention can exhibit superior seam strength and exert high performance in spite of internal impact such as high pressure and heat, since it is manufactured using sewing yarns containing aramid fibers.

In addition, the airbag according to the present invention can exhibit superior adhesion and foldability, since it is coated under optimal conditions with a polyurethane resin or silicone resin.

The airbag of the present invention exhibits superior impact resistance, heat resistance and friction resistance and is thus useful as an automobile external airbag.

### DESCRIPTION OF DRAWINGS

The above and other objects, features and other advantages of the present invention will be more clearly understood from the following detailed description taken in conjunction with the accompanying drawings, in which:

FIG. 1 is a sectional view illustrating an airbag according to one embodiment of the present invention;

FIG. 2 is a sectional view illustrating an airbag in which a part of monofilaments constituting a fabric is coated with a resin, according to one embodiment of the present invention;

FIG. 3 is a sectional view of an airbag according to one embodiment of the present invention, illustrating a ratio of a depth of the coating layer permeated into the fabric to a fabric thickness; and

FIG. 4 is a schematic view illustrating a method for folding an airbag during measurement of foldability.

### BEST MODE

Those skilled in the art will appreciate that various modifications, additions and substitutions are possible, without departing from the scope and spirit of the invention as disclosed in the accompanying claims. Accordingly, the present invention covers all such modifications and substitutions which fall within the scope of the invention as disclosed in the accompanying claims and equivalents thereof.

Hereinafter, an airbag and a method for manufacturing the same according to embodiments of the present invention will be described in more detail with reference to the following preferred examples.

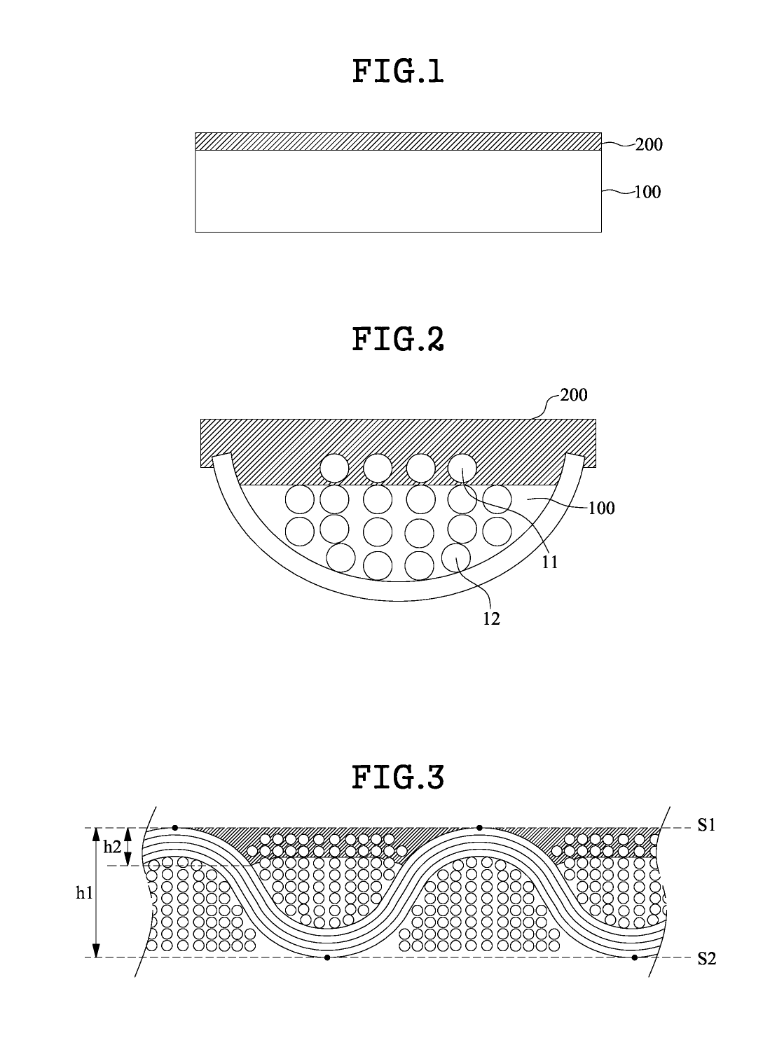

FIG. 1 is a sectional view illustrating an airbag according to one embodiment of the present invention. As shown in FIG. 1, the airbag of the present invention includes a fabric 100 containing an aramid fiber.

In a general airbag system, when an automobile collides, an impact sensor senses collision and transfers a signal to an electronic control module. The electronic control module which receives the signal from the impact sensor ignites a detonator to combust gunpowder mounted in the inflator. The gas generated by such combustion inflates an airbag cushion. In particular, an airbag mounted in an external component of an automobile such as a bumper is directly exposed to strong external impact. Furthermore, an external airbag protects a wide area, thus entailing use of a relatively great amount of gunpowder and receiving a great internal impact.

Commonly, conventional airbags are manufactured using a nylon fiber which exhibits relatively superior physical properties and excellent adhesion to a coating resin. However, when an airbag made of a nylon fiber is used for external use, disadvantageously, automobiles and passengers cannot be protected from external and internal impacts of high temperature and high pressure, since the nylon fiber has relatively low heat resistance and tenacity.

In an attempt to solve problems associated with nylon fibers, the airbag of the present invention comprises a fabric 100 weaved with an aramid fiber having an young's modulus of 600 to 1000 g/d and a tenacity of 20 to 30 g/d.

The aramid fiber has an young's modulus of 600 to 1000 g/d. When the young's modulus of the aramid fiber is below 600 g/d, the fabric may be readily damaged by impact, and when the young's modulus of the aramid fiber is above 1000 g/d, the fabric cannot be easily folded and foldability, a physical property indicating a folding level may be deteriorated.

The aramid fiber may have a tenacity of 20 to 30 g/d. When the tenacity of the aramid fiber is below 20 g/d, the fabric 100 may be torn by impact and when the tenacity of the aramid fiber is above 30 g/d, production efficiency may be deteriorated due to difficulty of manufacture of the fabric 100.

Meanwhile, fabrics made of aramid fiber alone cannot be easily folded. When such fabric is used, it is impossible to manufacture airbags with high integration. Accordingly, in accordance with one embodiment of the present invention, to improve foldability of the fabric 100, a fabric 100 composed of a mixture of a nylon 66 fiber having a relatively low young's modulus and an aramid fiber may be used. The nylon 66 filament may be used in an amount required for improvement in foldability of the fabric.

The fabric 100 containing an aramid fiber may have a tenacity (measured in accordance with ASTM D 5034) of 130 to 200 kfg/10 mm. That is, the fabric 100 containing an aramid fiber according to the present invention has superior tenacity and is resistant to damage by strong impact, high friction, high pressure and high temperature, and an airbag made of the fabric 100 of the present invention efficiently absorbs impact applied to automobiles and can safely protect automobiles and passengers.

When the tenacity of the fabric 100 is lower than 130 kgf/10 mm, the fabric 100 may be broken by strong impact and high friction externally resulting from automobile collision, and high temperature and high pressure internally resulting from gunpowder gas. On the other hand, when the tenacity of the fabric 100 is above 200 kgf/10 mm, economic efficiency may be deteriorated due to difficultly in manufacture of the fabric 100.

The fabric 100 may not be melted when flammability is measured using a 600° C. flame. As such, the fabric 100 having superior heat resistance can avoid both great damage even upon exposure to high temperature and high pressure gas and breakage upon exposure to external friction. Accordingly, airbags manufactured from the fabric 100 can efficiently absorb external and internal impact resulting from automobile collision and thus safely protect automobiles and passengers.

The fabric 100 according to one embodiment of the present invention may have a cover factor of 500 to 2100. Cover factor is a density of woven fabric based on denier. When the cover factor of the fabric 100 is lower than 1500, air barrier properties are degraded, seam strength becomes weak and airbags thus cannot exert performance due to excessively low density. On the other hand, when the cover factor of the fabric 100 is above 2100, manufacturing and joining of fabric 100 may be difficult due to excessively high density.

The cover factor may be calculated by the following equations:

Cover factor=warp cover factor+weft cover factor

Warp cover factor=warp density (warp number/inch)×√deniers

Weft cover factor=weft density (weft number/inch)×√deniers

Meanwhile, the fabric 100 weaved with only an aramid fiber may exhibit low integration due to relatively low foldability thereof. This may be an obstacle in reducing airbag volume.

Accordingly, as shown in FIG. 1, the airbag of the present invention may further comprise a coating layer 200 formed on the surface of the fabric 100. The coating layer 200 smoothes the surface of the fabric 100, protects the fabric 100 from external impact, maximizes air barrier effects and thus improves impact absorbance performance of airbags.

The coating layer 200 may contain a polyurethane resin or a silicone resin. The coating layer 200 containing a polyurethane resin imparts flexibility to the fabric 100 and thus improves foldability of the fabric 100. In addition, the coating layer 200 containing a polyurethane resin has superior adhesion to aramid fibers and thus maximizes air barrier properties of the fabric 100. In addition, the coating layer 200 improves anti-collision properties and durability of airbags and thus enables performance of airbags to be maintained for a long period of time.

The coating layer 200 containing a silicone resin can impart superior heat resistance, cold resistance and air barrier properties to the fabric 100.

FIG. 2 is a sectional view illustrating an airbag in which a part of monofilaments constituting a fabric is coated with a resin, according to one embodiment of the present invention. As shown in FIG. 2, the fabric 100 according to one embodiment of the present invention contains a plurality of first monofilaments 11 coated with the coating layer 200 and a plurality of second monofilaments 12 not coated with the coating layer 200. Only the monofilaments 11, a part of the monofilaments 11 and 12 constituting the fabric 100, are coated with the coating layer 200. Accordingly, the airbag of the present invention yields both flexibility and adhesion. That is, by coating only the first monofilaments 11 among the monofilaments 11 and 12 constituting the fabric 100 with a resin, adhesion between the coating layer 200 and the fabric 100 can be improved. In addition, since the second monofilaments 12 of the fabric 100 are not coated with the resin, the fabric 100 can maintain superior flexibility.

In accordance with one embodiment of the present invention, the number of the first monofilaments 11 is 5 to 30% of the total number of the monofilaments 11 and 12 constituting the fabric 100. For example, in the embodiment as shown in FIG. 2, among 20 monofilaments 11 and 12 constituting the fabric 100, the number of the first monofilaments 11 completely coated with the resin is 4 and the ratio of the first monofilaments 11 coated with the resin to the monofilaments 11 and 12 of the fabric 100 is 20%.

When the ratio of the first monofilaments 11 coated with the resin is lower than 5%, the fabric 100 can maintain superior flexibility, but adhesion between the fabric 100 and the coating layer 200 is deteriorated. On the other hand, when the ratio of the first monofilaments 11 coated with the resin is higher than 30%, flexibility of the fabric 100 is sharply deteriorated.

FIG. 3 is a sectional view of an airbag according to one embodiment of the present invention, illustrating a ratio of a depth of the coating layer permeated into the fabric to a fabric thickness.

In accordance with one embodiment of the present invention, the depth of the coating layer permeated into the fabric is 10 to 60% of the fabric thickness. When the ratio of the depth of the coating layer permeated into the fabric is lower than 10%, the fabric 100 can maintain superior flexibility, but adhesion between the fabric and the coating layer may be deteriorated. On the other hand, when the ratio of the depth of the coating layer permeated into the fabric is higher than 60%, flexibility of the fabric 100 may be sharply deteriorated.

Hereinafter, referring to FIG. 3, a method for measuring a permeation ratio of the coating layer will be described. First, the distance between a first base line S1 and a second base line S2 is measured to obtain a fabric thickness h1, a maximum depth h2 of the coating layer permeated into the fabric from the first base line S1 is measured and a ratio of permeated resin is calculated via the following equation.

Ratio of permeated resin=h2/h1×100

The airbag of the present invention may comprise a joined portion in which the fabric 100 is joined with a sewing yarn comprising an aramid fiber.

The sewing yarns for joining of the fabric 100 are generally nylon cotton yarns. The joined portion joined by the nylon cotton yarns has relatively low seam strength and thus tears or is seriously damaged by high temperature and high pressure gas generated during airbag operation.

The sewing yarn according to one embodiment of the present invention contains an aramid fiber having a high tenacity of 20 g/d or higher and the airbag including a joined portion formed by means of the sewing yarn according to the present invention can avoid damage by internal collision such as high-temperature and high-pressure gas as well as external collision and can efficiently absorb impact.

A joined portion formed by means of a sewing yarn containing an aramid fiber having a high tenacity of 20 g/d or higher has a seam strength of 200 to 600 kgf/20 mm or higher. If the seam strength of the joined portion is lower than 200 kgf/20 mm, sewing yarns may unravel during collision, a gas is discharged during operations of airbags and external impact cannot be suitably absorbed by the airbags. On the other hand, when the seam strength of the joined portion is higher than 600 kgf/20 mm, production costs may be greatly increased due to excessive seam strength and airbags may operate abnormally.

Hereinafter, a method for manufacturing an airbag according to one embodiment of the present invention will be described in detail.

First, a fabric 100 was prepared using an aramid fiber. As mentioned above, the aramid fiber has an young's modulus of 600 to 1000 g/d and a tenacity of 20 to 30 g/d.

In order to realize ease of a weaving process and optimal fabric density, the aramid fiber may have 600 to 1000 deniers and each of a plurality of monofilaments constituting the aramid fiber may have 0.9 to 1.5 deniers.

The fabric 100 is a woven fabric which may have any of a variety of weaving shapes. That is, the fabric 100 may be prepared by weaving an aramid fiber by one of various methods such as plain weaving, twill weaving, warp satin weaving or any other weaving method.

In order to improve foldability of the fabric 100, weaving may be performed using a mixed yarn of aramid and nylon or in combination of an aramid fiber with a nylon fiber.

Subsequently, the fabric 100 is scoured.

The scouring process is performed under an alkali environment at high temperature and physical properties of the fabric 100 are thus readily deteriorated. Accordingly, according to the present invention, the scouring process is performed under mild conditions so that strength maintenance after scouring is 90% or more, as compared to the fabric before scouring.

More specifically, the scouring process includes immersing the fabric 100 in a cleaning solution which is maintained at a temperature of 50 to 80° C. The cleaning solution may be an aqueous solution containing 0.2 to 10 g/L of Na₂CO₃ or 0.2 to 5 g/L of NaOH, and 0.2 to 10 g/L of a surfactant. The cleaning solution having such concentration range is used in order to minimize deterioration in physical properties of the fabric 100 and remove impurities, in particular, an oil, contained in the fabric 100. In particular, NaOH is preferably used in a concentration of 5 g/L or lower, since it is strong alkaline. Meanwhile, when the concentration of Na₂CO₃ or NaOH is below 0.2 g/L, cleaning performance is deteriorated and a relatively large amount of oil remains on the fabric 100. The residual oil may deteriorate adhesion between the resin and the surface of the fabric 100 during coating, as is mentioned below.

The scouring process may further include washing the fabric to remove lots of cleaning components and foreign materials from the fabric 100 treated with the cleaning solution. The washing may be performed using pure water. In order to improve washing efficiency, the washing process may be performed at a temperature of 50° C. or higher.

The scouring process may be repeated several times. That is, the immersing and washing processes may be repeated 2 to 5 times in order to sufficiently remove the oil from the fabric 100.

Then, in order to remove moisture from the fabric 100 and smooth the surface of the fabric 100, the washed fabric 100 may be heat-treated. Heat-treatment temperature and time should be determined such that damage of the fabric 100 is prevented and uniform appearance can be obtained.

Then, the surface of the heat-treated fabric 100 is coated with a resin to form a coating layer 200 on at least one surface of the fabric 100. The fabric 100 provided on at least one surface thereof with the coating layer 200 exhibits improved air barrier properties. In addition, the coating layer 200 protects the fabric 100 from the high temperatures generated by the inflator.

According to the present invention, the heat-treated fabric 100 contains 0.2% by weight or lower of an oil and thus enables strong adhesion between the fabric 100 and the coating layer 200. If the content of residual oil present in the fabric 100 is higher than 0.2% by weight, the resin cannot be easily adhered to the fabric 100 due to the oil and airbag performance may thus be deteriorated. That is, since a coating solution cannot sufficiently strongly adhered to the surface of the fabric 100, air permeation property of the airbags increases and anti-impact property thereof is deteriorated.

According to the present invention, the fabric 100 contains both first monofilaments coated with the coating layer 200 and second monofilaments not coated with the coating layer 200, thus imparting superior flexibility to airbags and improving adhesion between the fabric 100 and the coating layer 200.

In accordance with one embodiment of the present invention, the number of the first monofilaments coated with the coating layer 200 is 5 to 30% of the total number of monofilaments constituting the fabric 100 and a depth of the coating layer 200 permeated into the fabric 100 is 10 to 60% of the thickness of the fabric 100. For this purpose, the viscosity of the resin solution, coating pressure and the amount of adhered resin are suitably controlled, when the coating layer 200 is formed on at least one surface of the fabric by coating the surface of the heat-treated fabric 100 with a resin, For example, as the viscosity of the resin solution decreases and coating pressure increases, the resin solution is readily permeated into the fabric 100 and the number of monofilaments coated with the resin increases, and a ratio of the depth of the permeated resin to the thickness of fabric 100 thus increases.

In order to form the coating layer 200, the resin coated on the fabric 100 may contain a polyurethane resin. Advantageously, the polyurethane resin can efficiently block permeation of air and thus improve durability due to superior adhesivity to the aramid fiber, and can improve flexibility of the fabric 100 due to the flexible molecular structure thereof.

Then, the fabric (hereinafter, referred to as “coated fabric”) at least one surface of which is coated with the coating layer 200 is cut to a predetermined shape. That is, since airbags may have a variety of shapes, the coated fabric is cut depending on the shape thereof.

Then, edge portions of the cut fabrics are joined using sewing yarns containing aramid fibers to complete an airbag. The joined portion of the airbag has a seam strength of 200 to 600 kgf/20 mm, since the aramid fibers constituting the sewing yarns has a tenacity of 20 g/d or more and the fabric 100 has a high density. The airbag including the joined portion having superior seam strength according to the present invention can maintain a stable shape and thus secures safety of automobiles and passengers, although colliding with high temperature and high-pressure gas generated during operation of an airbag.

Hereinafter, the present invention will be described in more detail with reference to the following examples. These examples are only provided to illustrate the present invention and should not be construed as limiting the scope and spirit of the present invention.

Airbags manufactured in accordance with Examples and Comparative Examples were evaluated via the following method.

Ratio of Monofilaments Coated on Resin

The cross-section image of an airbag in the warp direction of the fabric 100 was obtained by scanning electron microscopy (SEM) and the number of monofilaments constituting one multifilament and the number of the monofilaments 11, the surface of which was entirely coated with a resin, were obtained from the image and a ratio of monofilaments coated on the resin was measured using the following equation.

Ratio of monofilaments coated with resin (%)=[(number of monofilaments coated with resin, among monofilaments constituting one multifilament)/(number of monofilaments constituting one multifilament)]×100

Ratio of Resin Permeation

The cross-section image of airbags was obtained by scanning electron microscopy and a distance at which the resin permeated inside from the surface of the fabric 100 and the thickness of the fabric 100 were calculated and a ratio of permeated resin was obtained in accordance with the following equation.

Ratio of resin permeation (%)=[(distance of resin permeation measured from the surface of fabric)/(fabric thickness)]×100

The distance of resin permeation was obtained, as shown in FIG. 3, by obtaining a first base line S1 from the highest point of weft multifilaments on the resin-coated surface to the second highest point, and measuring the shortest distance h2 from the first base line S1 to a position at which the resin was permeated to a maximum level. In addition, as shown in FIG. 3, the fabric thickness was obtained by obtaining a second base line S2 between the lowest point of weft multifilaments and the second lowest point thereof and measuring the shortest distance h1 between the first base line which passes a point at which the resin is permeated at a maximum level and the second base line S2.

Content of Oil

First, a specimen was weighed (W1), dried at 105° C. for 2 hours, allowed to stand in a desiccator for 30 minutes, and weighed again (W2). Then, the specimen was treated with a scouring agent for 10 minutes, dried at 105° C. for 2 hours and the dried specimen was allowed to stand in a desiccator for 30 minutes and then weighed (W3). Methanol was used as the scouring agent and oil pick-up (OPU) was calculated by the following equation 1.

Content of oil (% by weight)=[(W2−W3)/W1]×100

Adhesion Between Fabric an Coating Layer

The coating layer was rubbed 500 times in accordance with JIS K 6328 (5.3.8) and then it was observed whether peeling of the coating layer occurred or not.

Foldability

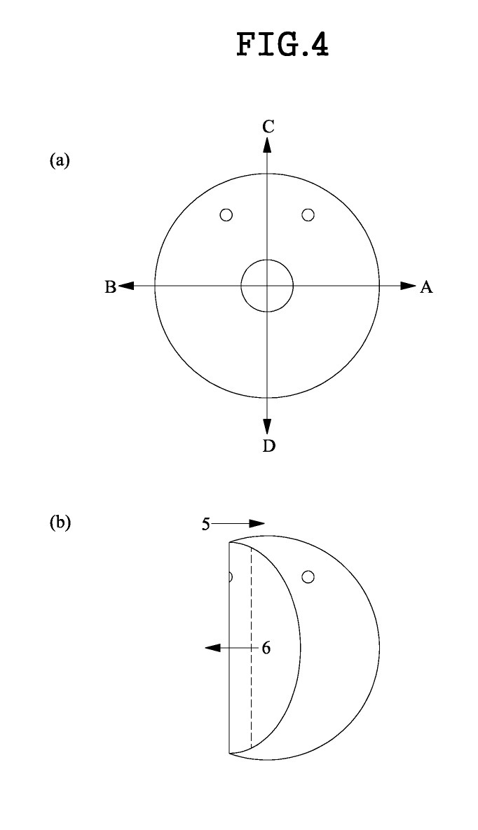

First, as shown in FIG. 4, the airbag part present at a left side based on a CD line was folded at a 270 mm line 5 in an A direction and the folded part was folded at a 200 mm line 6 in a B direction, and the resulting folded part was folded at a 130 mm line in an A direction. Similarly, the airbag part present at a right side based on the CD line was folded at the 270 mm line in the B direction, at the 200 mm line in the A direction and at the 130 mm line in the B direction in this order.

Then, the airbag part at an upper side based on an AB line was folded at the 270 mm line in a D direction, at a 105 mm line in a C direction, and at a 75 mm line in the C direction in this order. The airbag part present at a lower side based on the AB line was folded at the 270 mm line in the C direction, at the 105 mm line in the D direction, and at the 75 mm line in the D direction in this order.

Finally, a folded airbag with a size of 150 mm×150 mm was obtained. The thickness (mm) of the folded airbag was measured 3 minutes after a load of 10N was applied thereto.

Tenacity of Airbag

The tenacity (kgf/10 mm) of airbag was measured in accordance with ASTM D 5034. At this time, the size of the measured specimen had a width of 10 mm and a length of 150 mm.

Seam Strength of Joined Portion

The seam strength (kgf/20 mm) of the joined portion was obtained by measuring the strength at the time when the specimen was broken, while setting the specimen on a lower clamp and moving an upper clamp upward, in accordance with ASTM D 1683. The size of the measured specimen had a width of 100 mm and a length of 120 mm.

Flammability of Airbag

Flammability of the airbag was measured to indirectly evaluate heat resistance of the airbag. The flammability of the airbag was evaluated by measuring a distance (mm/min) at which the coated fabric was burned per minute in accordance with FMVSS-302.

Strength and Young's Modulus of Filaments

The strength (g/d) and young's modulus (g/d) of the filaments were measured with a tester (Instron Engineering Corp, Canton, Mass.) at a tension rate of 300 mm/min and at an initial load of denier× 1/30 g using a sample with a length of 25 cm.

### EXAMPLE 1

Weaving was performed using aramid fibers (840 denier/560 filaments) having a tenacity of 26 g/d and an young's modulus of 800 g/d as wefts and warps to obtain a plane woven fabric having a cover factor of 1,725.

Then, the fabric was immersed in a scouring bath containing a cleaning solution comprising 0.3 g/L of NaOH and 0.2 g/L of an ethoxylated alcohol-based nonionic surfactant. The immersion was performed twice in a scouring bath at a temperature of 60° C., three times in a scouring bath at a temperature of 70° C., and three times in a scouring bath at a temperature of 80° C. Then, the fabric was washed by immersing the same in a washing bath. At this time, the washing bath was maintained at 60° C. and immersion was repeated 4 times to perform washing. Then, the washed fabric was dried at a temperature of 100° C. and heat-treated at 180° C. to obtain a scoured fabric.

Then, the scoured fabric was coated with an aqueous polyurethane resin solution (resin solid: 50%) having a viscosity of 10 Pa·s using a floating knife coater utilizing a knife at a contact pressure between the fabric and the knife of 6 N/cm such that the amount of adhered resin was adjusted to 50 g/m², and heat-treated at 210° C. to obtain a coated fabric.

Then, the coated fabric was cut to a predetermined shape using a laser cutter.

Then, stitching was performed using aramid sewing yarns (1200 denier) having a tenacity of 21 g/d such that the number of stitches was adjusted to 30 ca/100 mm to manufacture an airbag.

### EXAMPLE 2

An airbag was manufactured in the same manner as in Example 1 except that the fabric was scoured using a cleaning solution of which the concentration of NaOH was 4 g/L.

### EXAMPLE 3

An airbag was manufactured in the same manner as in Example 1 except that the fabric was woven with a fiber made by mixing a nylon 66 fiber (620 denier) having a tenacity of 8 g/d and an aramid fiber with a ratio of 0.2:0.8.

### EXAMPLES 4 AND 5

Airbags were manufactured in the same manner as in Example 1 except that the plane woven fabrics were made such that the cover factors thereof were 1550 and 2050, respectively.

### COMPARATIVE EXAMPLE 1

An airbag was manufactured in the same manner as in Example 1 except that the fabric was woven with a nylon 66 fiber (840 denier) having a tenacity of 8 g/d instead of the aramid fiber.

### COMPARATIVE EXAMPLE 2

An airbag was manufactured in the same manner as in Example 1 except that the fabric was scoured using a cleaning solution of which the concentration of NaOH was 6 g/L.

### COMPARATIVE EXAMPLE 3

An airbag was manufactured in the same manner as in Example 1 except that nylon 66 sewing yarns having a tenacity of 8 g/d were used instead of the aramid sewing yarns.

### COMPARATIVE EXAMPLE 4

An airbag was manufactured in the same manner as in Example 1 except that the fabric was woven with a nylon 66 fiber having a tenacity of 8 g/d instead of the aramid fiber and was coated at a contact pressure of 0.1 N/cm.

### COMPARATIVE EXAMPLE 5

An airbag was manufactured in the same manner as in Example 1 except that the fabric was woven with a nylon 66 fiber having a tenacity of 8 g/d instead of an aramid fiber and was coated with an aqueous polyurethane resin solution (resin solid: 50%) having a viscosity of 10 Pa·s using a floating knife coater utilizing a knife at a contact pressure between the fabric and the knife of 6 N/cm such that the amount of adhered resin was adjusted to 10 g/m².

### COMPARATIVE EXAMPLES 6 AND 7

Airbags were manufactured in the same manner as in Example 1 except that weaving was performed such that the cover factors of the plane woven fabrics were 1450 and 2150, respectively.

Flammability, tenacity, seam strength, foldability and adhesion of airbags obtained in Examples and Comparative Examples were measured in accordance with the method mentioned above and the results thus obtained are shown in Table 1.

TABLE 1

| | | | | | | Ratio of | |
|---|---|---|---|---|---|---|---|
| | Tenacity | | | | | monofilaments | Ratio of |
| | of | | Seam | | | coated | resin |
| | airbag | Flammability | strength | | Foldability | with resin | permeation |
| | (kgf/10 mm) | (mm/min) | (kgf/20 mm) | Adhesion | (mm) | (%) | (%) |
| Ex. 1 | 175 | Self- | 315 | ◯ | 30 | 18 | 54 |
| | | extinguished | | | | | |
| Ex. 2 | 140 | Self- | 306 | ◯ | 31 | 18 | 55 |
| | | extinguished | | | | | |
| Ex. 3 | 132 | Self- | 301 | ◯ | 34 | 22 | 58 |
| | | extinguished | | | | | |
| Ex. 4 | 166 | Self- | 218 | ◯ | 29 | 19 | 58 |
| | | extinguished | | | | | |
| Ex. 5 | 178 | Self- | 381 | ◯ | 31 | 18 | 53 |
| | | extinguished | | | | | |
| Comp. | 76 | 101 | 286 | ◯ | 36 | 20 | 56 |
| Ex. 1 | | | | | | | |
| Comp. | 128 | Self- | 292 | ◯ | 34 | 20 | 57 |
| Ex. 2 | | extinguished | | | | | |
| Comp. | 175 | Self- | 158 | ◯ | 31 | 22 | 56 |
| Ex. 3 | | extinguished | | | | | |
| Comp. | 76 | 98 | 283 | X | 37 | 0 | 70 |
| Ex. 4 | | | | | | | |
| Comp | 76 | 95 | 281 | ◯ | 50 | 100 | 91 |
| Ex. 5 | | | | | | | |
| Comp. | 151 | Self- | 197 | ◯ | 30 | 20 | 60 |
| Ex. 6 | | extinguished | | | | | |
| Comp. | 179 | Self- | 425 | ◯ | 46 | 15 | 51 |
| Ex. 7 | | extinguished | | | | | |

1. An airbag comprising:
a fabric comprising an aramid fiber having an young's modulus of 600 to 1000 g/d and a tenacity of 20 to 30 g/d, and having a cover factor of 1500 to 2100; and
a coating layer formed on a surface of the fabric,
wherein a seam strength of a joined portion measured in accordance with ASTM D 1683 is 200 to 600 kgf/20 mm.

2. The airbag according to claim 1, wherein the joined portion is formed by joining the fabric using a sewing yarn and the sewing yarn comprises an aramid fiber.

3. The airbag according to claim 1, wherein the tenacity of the airbag measured in accordance with ASTM D 5034 is 130 to 200 kgf/10 mm.

4. The airbag according to claim 1, wherein the fabric has a self-extinguishing property when flammability is measured in accordance with FMVSS-302.

5. The airbag according to claim 1, wherein the fabric comprises 0.2% by weight or lower of an oil.

6. The airbag according to claim 1, wherein the fabric further comprises a nylon 66 filament.

7. The airbag according to claim 1, wherein the coating layer comprises a polyurethane resin or silicone resin.

8. The airbag according to claim 1, wherein the fabric comprises first monofilaments coated with the coating layer and second monofilaments not coated with the coating layer, and the number of the first monofilaments is 5 to 30% of the total number of monofilaments constituting the fabric.

9. The airbag according to claim 1, wherein a depth at which the coating layer is permeated into the fabric is 10 to 60% of a thickness of the fabric.

10. A method for manufacturing an airbag, the method comprising:
preparing a fabric comprising an aramid fiber having an young's modulus of 600 to 1000 g/d and a tenacity of 20 to 30 g/d, and having a cover factor of 1500 to 2100;
scouring the fabric;
coating a resin on a surface of the scoured fabric;
cutting the coated fabric to a predetermined shape; and
joining the cut fabric using a sewing yarn comprising an aramid fiber such that a seam strength of 200 to 600 kgf/20 mm is obtained.

11. The method according to claim 10, wherein a content of an oil present in the fabric is reduced to 0.2% by weight or lower through the scouring.

12. The method according to claim 10, wherein the scouring comprises:
immersing the fabric in a 50 to 80° C. cleaning solution containing 0.2 to 10 g/L of Na₂CO₃ or 0.2 to 5 g/L of NaOH, and 0.2 to 10g/L of a surfactant; and
washing the fabric.

13. The method according to claim 12, wherein the scouring further comprises heat-treating the washed fabric at 120 to 200° C.

14. The method according to claim 10, wherein the coating is performed such that the number of monofilaments coated with the resin is 5 to 30% of the total number of monofilaments of the fabric.

15. The method according to claim 14, wherein the coating is performed such that a depth to which the resin permeates the fabric is 10 to 60% of a thickness of the fabric.
